(19) United States
(12) Patent Application Publication
(10) Pub. No.: US 2020/0019839 A1
(43) Pub. Date: Jan. 16, 2020

(54) METHODS AND APPARATUS FOR SPIKING NEURAL NETWORK COMPUTING BASED ON THRESHOLD ACCUMULATION

(71) Applicant: The Board of Trustees of the Leland Stanford Junior University, STANFORD, CA (US)

(72) Inventors: Kwabena Adu Boahen, Stanford, CA (US); Sam Brian Fok, Stanford, CA (US); Alexander Smith Neckar, Stanford, CA (US); Ben Varkey Benjamin Pottayil, Stanford, CA (US); Terrence Stewart, Stanford, CA (US); Nick Nirmal Oza, Palo Alto, CA (US); Rajit Manohar, New Haven, CT (US); Christopher David Eliasmith, Stanford, CA (US)

(21) Appl. No.: 16/508,123

(22) Filed: Jul. 10, 2019

Related U.S. Application Data
(60) Provisional application No. 62/696,713, filed on Jul. 11, 2018.

(51) Int. Cl. G06N 3/04; G06N 3/063

(52) U.S. Cl. CPC G06N 3/049; G06N 3/0635

(57) ABSTRACT

Methods and apparatus for spiking neural network computing based on e.g., a multi-layer kernel architecture, shared dendritic encoding, and/or thresholding of accumulated spiking signals. In one embodiment, a thresholding accumulator is disclosed that reduces spiking activity between different stages of a neuromorphic processor. Spiking activity can be directly related to power consumption and signal-to-noise ratio (SNR); thus, various embodiments trade-off the costs and benefits associated with threshold accumulation. For example, reducing spiking activity (e.g., by a factor of 10) during an encoding stage can have minimal impact on downstream fidelity (SNR) for a decoding stage, while yielding substantial improvements in power consumption.

### PRIORITY AND RELATED APPLICATIONS

This application claims the benefit of priority to U.S. Provisional Patent Application Ser. No. 62/696,713 filed Jul. 11, 2018 and entitled “METHODS AND APPARATUS FOR SPIKING NEURAL NETWORK COMPUTING”, which is incorporated herein by reference in its entirety.

This application is related to U.S. patent application Ser. No. ______ filed contemporaneously herewith on Jul. 10, 2019 and entitled “METHODS AND APPARATUS FOR SPIKING NEURAL NETWORK COMPUTING BASED ON A MULTI-LAYER KERNEL ARCHITECTURE”, U.S. patent application Ser. No. ______ filed contemporaneously herewith on Jul. 10, 2019 and entitled “METHODS AND APPARATUS FOR SPIKING NEURAL NETWORK COMPUTING BASED ON RANDOMIZED SPATIAL ASSIGNMENTS”, and U.S. patent application Ser. No. 16/358,501 filed Mar. 19, 2019 and entitled “METHODS AND APPARATUS FOR SERIALIZED ROUTING WITHIN A FRACTAL NODE ARRAY”, each of the foregoing being incorporated herein by reference in its entirety.

### STATEMENT REGARDING FEDERALLY SPONSORED RESEARCH OR DEVELOPMENT

This invention was made with Government support under contract N00014-15-1-2827 awarded by the Office of Naval Research, under contract N00014-13-1-0419 awarded by the Office of Naval Research and under contract NS076460 awarded by the National Institutes of Health. The Government has certain rights in the invention.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. TECHNICAL FIELD

The disclosure relates generally to the field of neuromorphic computing, as well as neural networks. More particularly, the disclosure is directed to methods and apparatus for spiking neural network computing based on e.g., a multi-layer kernel architecture, shared dendritic encoding, and/or thresholding of accumulated spiking signals.

### 2. DESCRIPTION OF RELATED TECHNOLOGY

Traditionally, computers include at least one processor and some form of memory. Computers are programmed by writing a program composed of processor-readable instructions to the computer's memory. During operation, the processor reads the stored instructions from memory and executes various arithmetic, data path, and/or control operations in sequence to achieve a desired outcome. Even though the traditional compute paradigm is simple to understand, computers have rapidly improved and expanded to encompass a variety of tasks. In modern society, they have permeated everyday life to an extent that would have been unimaginable only a few decades ago.

While the general compute paradigm has found great commercial success, modern computers are still no match for the human brain. Transistors (the components of a computer chip) can process many times faster than a biological neuron; however, this speed comes at a significant price. For example, the fastest computers in the world can perform nearly a quadrillion computations per second (10¹⁶ bits/second) at a cost of 1.5 megawatts (MW). In contrast, a human brain contains ˜80 billion neurons and can perform approximately the same magnitude of computation at only a fraction of the power (about 10 watts (W)).

Incipient research is directed to so-called “neuromorphic computing” which refers to very-large-scale integration (VLSI) systems containing circuits that mimic the neuro-biological architectures present in the brain. While neuromorphic computing is still in its infancy, such technologies already have great promise for certain types of tasks. For example, neuromorphic technologies are much better at finding causal and/or non-linear relations in complex data when compared to traditional compute alternatives. Neuromorphic technologies could be used for example to perform speech and image recognition within power-constrained devices (e.g., cellular phones, etc.) Conceivably, neuromorphic technology could integrate energy-efficient intelligent cognitive functions into a wide range of consumer and business products, from driverless cars to domestic robots.

Neuromorphic computing draws from hardware and software models of a nervous system. In many cases, these models attempt to emulate the behavior of biological neurons within the context of existing software processes and hardware structures (e.g., transistors, gates, etc.) Unfortunately, some synergistic aspects of nerve biology have been lost in existing neuromorphic models. For example, biological neurons minimize energy by only sparingly emitting spikes to perform global communication. Additionally, biological neurons distribute spiking signals to dozens of targets at a time via localized signal propagation in dendritic trees. Neither of these aspects are mimicked within existing neuromorphic technologies due to issues of scale and variability.

To these ends, novel neuromorphic structures are needed to efficiently emulate nervous system functionality. Ideally, such solutions should enable mixed-signal neuromorphic circuitry to compensate for one or more of component mismatches and temperature variability, thereby enabling low-power operation for large scale neural networks. More generally, improved methods and apparatus are needed for spiking neural network computing.

### SUMMARY

The present disclosure satisfies the foregoing needs by providing, inter alia, methods and apparatus for spiking neural network computing based on e.g., a multi-layer kernel architecture, shared dendritic encoding, and/or thresholding of accumulated spiking signals.

In one aspect, a thresholding accumulator apparatus is disclosed. In one exemplary embodiment, the thresholding apparatus includes: a first interface coupled to one or more first spiking neural network elements; a second interface coupled to one or more second spiking neural network elements; logic configured to store an intermediary value based at least in part on one or more input spike trains received from the one or more first spiking neural network elements; and logic configured to generate an output spike train for transmission to the one or more second spiking neural network elements when an intermediary value meets at least one first prescribed criterion.

In one variant of the apparatus, the at least one first prescribed criterion comprises a threshold, the threshold selected based at least on a desired signal-to-noise ratio (SNR) associated with the output spike train. In one such variant, the threshold is further selected based on a corresponding cost of memory accesses to the decoding weight memory component.

In another variant of the apparatus, the thresholding accumulator further includes logic configured to generate another output spike train for transmission to the one or more second spiking neural network elements when the accumulated intermediary value meets at least one second prescribed criterion. In one such variant, the thresholding accumulator further includes logic configured to set the intermediary value to zero whenever an output spike of the output spike train is generated.

In a further variant, the thresholder accumulator apparatus also includes: logic configured to increase the accumulated intermediary value based on the one or more input spike trains; and logic configured to decrease the accumulated intermediary value based on the output spike train.

In another variant, the one or more first spiking neural network elements includes digital decode logic and the one or more second spiking neural network elements includes analog encode circuitries.

In another aspect, a method for accumulating spiking signaling in a multi-layer kernel architecture is disclosed. In one embodiment, the method includes: receiving an input spike from a first layer of a multi-layer kernel architecture; storing an intermediary value based on the input spike; and generating an output spike for a second layer of the multi-layer kernel architecture when the intermediary value exceeds a threshold.

In one variant of the method, the method further includes: accessing a decoding weight memory apparatus to retrieve a decode weight; and multiplying and accumulating the input spike from the first layer of the multi-layer kernel apparatus with the intermediary value based on the decode weight.

In another variant of the method, the first layer of the multi-layer kernel architecture is associated with a first signal-to-noise ratio (SNR), and the second layer of the multi-layer kernel architecture is associated with a second SNR. In one such variant, the method also includes selecting the threshold based on an acceptable difference between the first SNR and the second SNR.

In a further variant, the method includes: selecting the threshold based on a number of spikes required to generate the output spike, where the number of spikes required to generate the output spike corresponds to an acceptable loss in fidelity.

In another variant, the method includes setting the intermediary value to zero when the output spike is generated.

In still a further variant, the method includes reducing the intermediary value by the threshold when the output spike is generated.

In another aspect, a multi-layer kernel apparatus is disclosed. In one embodiment, the multi-layer kernel apparatus includes: a first stage of a multi-layer kernel configured to generate a first spike activity; a second stage of a multi-layer kernel configured to generate a second spike activity; and logic configured to isolate the first spike activity from the second spike activity.

In one variant, the first and second stages are of the same multi-layer kernel; the first stage of the multi-layer kernel is digital decode logic, and the second stage of the multi-layer kernel is analog encode circuitry.

In another variant multi-layer kernel apparatus, the first spike activity occurs according to a first average spike rate and has a first signal-to-noise ratio (SNR); and the second spike activity occurs according to a second average spike rate and has a second SNR. In one such variant, the first average spike rate exceeds the second average spike rate by at least a magnitude of ten (10). In another such variant, the second SNR differs from the first SNR by a prescribed loss factor. In still another variant, the prescribed loss factor is dynamically adjustable based on at least one of (i) manual input by a user; and/or (ii) algorithmically generated input.

In another aspect, a non-transitory computer-readable medium implementing one or more of the foregoing aspects is disclosed and described. In one embodiment, the non-transitory computer-readable medium includes one or more instructions which are configured to, when executed by a processor: receive an input spike from a first layer of a multi-layer kernel architecture; store an intermediary value based on the input spike; and generate an output spike for a second layer of the multi-layer kernel architecture when the intermediary value exceeds a threshold.

In another aspect, an integrated circuit (IC) device implementing one or more of the foregoing aspects is disclosed and described. In one embodiment, the IC device is embodied as a SoC (system on Chip) device. In another embodiment, an ASIC (application specific IC) is used as the basis of the device. In yet another embodiment, a chip set (i.e., multiple ICs used in coordinated fashion) is disclosed.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a logical block diagram of an exemplary neural network, useful for explaining various principles described herein.

FIG. 2A is a side-by-side comparison of (i) an exemplary two-layer reduced rank neural network implementing a set of weighted connections, and (ii) an exemplary three-layer reduced rank neural network implementing the same set of weighted connections, useful for explaining various principles described herein.

FIG. 2B is a graphical representation of an approximation of a mathematical signal represented as a function of neuron firing rates, useful for explaining various principles described herein.

FIG. 3 is a graphical representation of one exemplary embodiment of a spiking neural network, in accordance with the various principles described herein.

FIG. 4 is a logical block diagram of one exemplary embodiment of a spiking neural network, in accordance with the various principles described herein.

FIG. 5 is a logical block diagram of one exemplary embodiment of a shared dendrite, in accordance with the various principles described herein.

FIG. 6 is a logical block diagram of one exemplary embodiment of a shared dendrite characterized by a dynamically partitioned structure and configurable biases, in accordance with the various principles described herein.

FIG. 7 is a logical block diagram of spike signal propagation via one exemplary embodiment of a thresholding accumulator, in accordance with the various principles described herein.

FIG. 8 is a graphical representation of an input spike train and a resulting output spike train of an exemplary thresholding accumulator, in accordance with the various principles described herein.

FIG. 9 a logical flow diagram of one exemplary embodiment of a method for accumulating spiking signaling in a multi-layer kernel architecture, in accordance with the various principles described herein.

All figures © Copyright 2018-2019 Stanford University, All rights reserved.

### DETAILED DESCRIPTION

Reference is now made to the drawings, wherein like numerals refer to like parts throughout.

### Detailed Description of Exemplary Embodiments

Exemplary embodiments of the present disclosure are now described in detail. While these embodiments are primarily discussed in the context of spiking neural network computing, it will be recognized by those of ordinary skill that the present disclosure is not so limited. In fact, the various aspects of the disclosure are useful in any device or network of devices that is configured to perform neural network computing, as is disclosed herein.

### Existing Neural Networks—

Many characterizations of neural networks treat neuron operation in a “virtualized” or “digital” context; each idealized neuron is individually programmed with various parameters to create different behaviors. For example, biological spike trains are emulated with numeric parameters that represent spiking rates, and synaptic connections are realized with matrix multipliers of numeric values. Idealized neuron behavior can be emulated precisely and predictably, and such systems can be easily understood by artisans of ordinary skill.

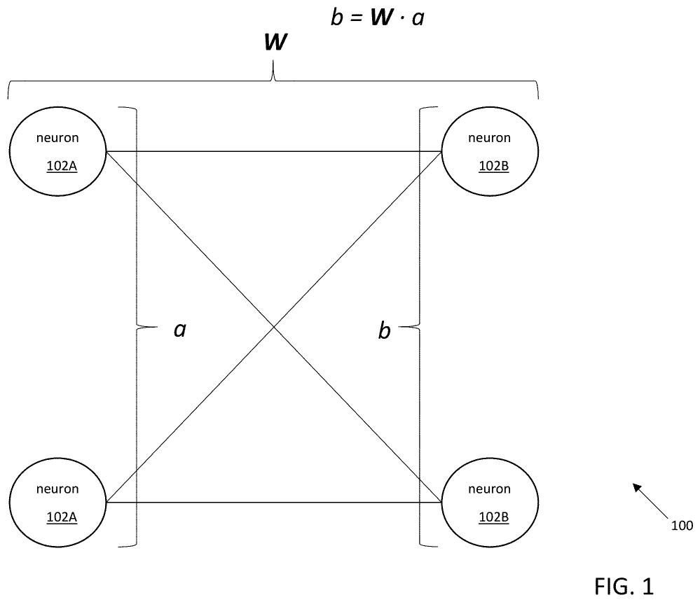

FIG. 1 is a logical block diagram of an exemplary neural network, useful for explaining various principles described herein. The exemplary neural network 100, and its associated neurons 102 are “virtualized” software components that represent neuron signaling with digital signals. As described in greater detail below, the various described components are functionally emulated as digital signals in software processes rather than e.g., analog signals in physical hardware components.

As shown in FIG. 1, the exemplary neural network 100 comprises an arrangement of neurons 102 that are logically connected to one another. As used herein, the term “ensemble” and/or “pool” refers to a functional grouping of neurons. In the illustrated configuration, a first ensemble of neurons 102A is connected to a second ensemble of neurons 102B. The inputs and outputs of each ensemble emulate the spiking activity of a neural network; however, rather than using physical spiking signaling, existing software implementations represent spiking signals with a vector of continuous signals sampled at a rate determined by the execution time-step.

During operation, a vector of continuous signals (a) representing spiking output for the first ensemble is transformed into an input vector (b) for a second ensemble via a weighting matrix (W) operation. Existing implementations of neural networks perform the weighting matrix (W) operation as a matrix multiplication. The matrix multiplication operations include memory reads of the values of each neuron 102A of the first ensemble, memory reads of the corresponding weights for each connection to a single neuron 102B of the second ensemble, and a multiplication and sum of the foregoing. The result is written to the neuron 102B of the second ensemble. The foregoing process is performed for each neuron 102B of the second ensemble.

As used in the present context, the term “rank” refers to the dimension of the vector space spanned by the columns of a matrix. A linearly independent matrix has linearly independent rows and columns. Thus, a matrix with four (4) columns can have up to a rank of four (4) but may have a lower rank. A “full rank” matrix has the largest possible rank for a matrix of the same dimensions. A “deficient,” “low rank” or “reduced rank” matrix has at least one or more rows or columns that are not linearly independent.

Any single matrix can be mathematically “factored” into a product of multiple constituent matrixes. Specifically, a “factorized matrix” is a “matrix” that can be represented as a product of multiple factor matrices. Only matrixes characterized by a deficient rank can be “factored” or “decomposed” into a “reduced rank structure”.

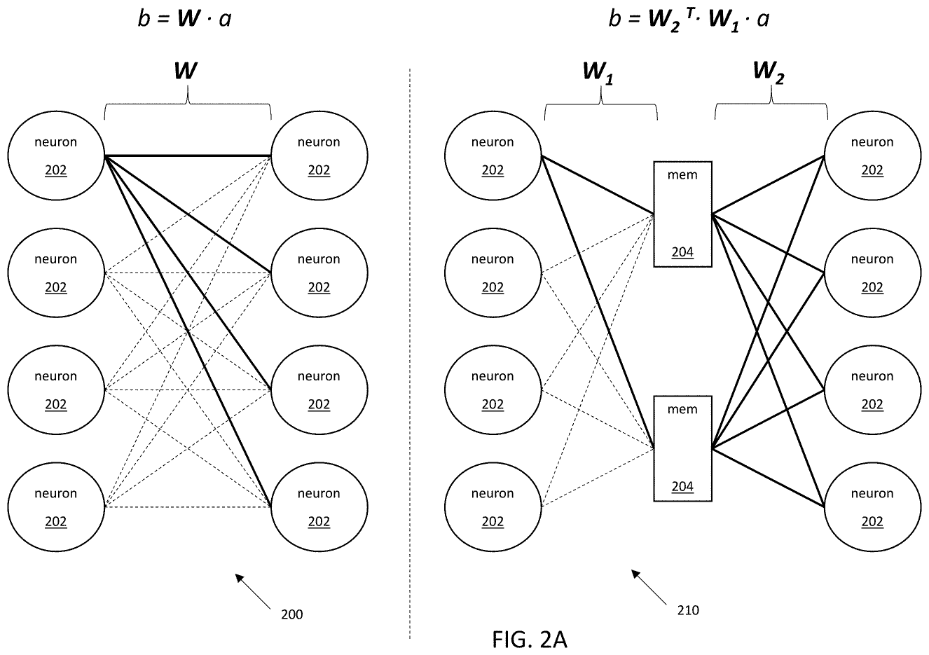

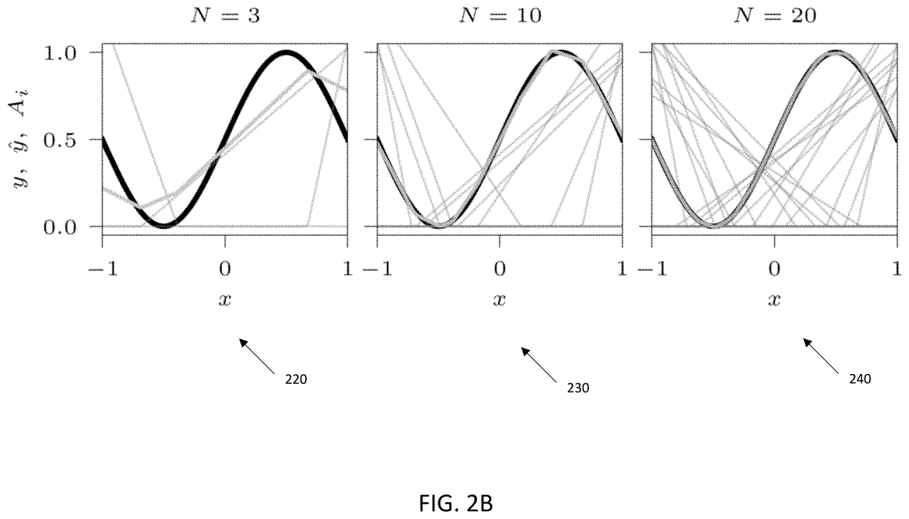

Referring now to FIG. 2A, a side-by-side comparison of an exemplary two-layer reduced rank neural network 200 implementing a set of weighted connections, and an exemplary three-layer reduced rank neural network 210 implementing the same set of weighted connections, is depicted. As shown therein, the weighted connections represented within a single weighting matrix (W) of a two-layer neural network 200 can be decomposed into a mathematically equivalent operation using two or more weighting matrices (W₁ and W₂) and an intermediate layer with a smaller dimension in the three-layer neural network 210. In other words, the weighting matrix W's low rank allows for the smaller intermediate dimension of two (2). In contrast, if the weighting matrix W was full rank, then the intermediate layer's dimension would be four (4).

Notably, each connection is implemented with physical circuitry and corresponds to a number of logical operations. For example, the number of connections between each layer may directly correspond to the number of e.g., computing circuits, memory components, processing cycles, and/or memory accesses. Consequently, even though a full rank matrix could be factored into mathematically identical full rank factor matrices, such a decomposition would increase system complexity (e.g., component cost, and processing/memory complexity) without any corresponding benefit.

More directly, there is a cost trade-off between connection complexity and matrix factorization. To illustrate the relative cost of matrix factorization as a function of connectivity, consider two (2) sets of neurons N₁, N₂. A non-factorized matrix has a connection between each one of the neurons (i.e., N₁×N₂ connections). In contrast, a factorized matrix has connections between each neuron of the first set (N₁) and intermediary memories D, and connections between each neuron of the second set (N₂) and the intermediary memories (i.e., N₁×D+N₂×D; or (N₁+N₂)×D connections). Mathematically, the cost/benefit “crossover” in connection complexity occurs where the number of connections for a factorized matrix equals the number of connections for its non-factorized matrix counterpart. In other words, the inflection point (D_{crossover}) is given by N₁×N₂/(N₁+N₂). Factorized systems with a larger D than D_{crossover} are inefficient compared to their non-factorized counterparts (i.e., with N₁×N₂ connections); systems with a smaller D than D_{crossover} are more efficient.

As one such example, consider the systems 200 and 210 of FIG. 2A. The non-factorized matrix of system 200 has 16 connections. For a N₁ and N₂ of four (4), D_{crossover} is two (2). Having more than two (2) intermediary memories results in a greater number of connections than the non-factorized matrix multiplication (e.g., a D of three (3) results in 24 connections; a D of four (4) results in 32 connections). Having fewer than two (2) intermediary memories results in fewer connections than the non-factorized matrix multiplication (e.g., a D of one (1) results in 8 connections).

As used herein, the terms “decompose”, “decomposition”, “factor”, “factorization” and/or “factoring” refer to a variety of techniques for mathematically dividing a matrix into one or more factor (constituent) matrices. Matrix decomposition may be mathematically identical or mathematically similar (e.g., characterized by a bounded error over a range, bounded derivative/integral of error over a range, etc.)

As used herein, the term “kernel” refers to an association of ensembles via logical layers. Each logical layer may correspond to one or more neurons, intermediary memories, and/or other sequentially distinct entities. The exemplary neural network 200 is a “two-layer” kernel, whereas the exemplary neural network 210 is a “three-layer” kernel. While the following discussion is presented within the context of two-layer and three-kernels, artisans of ordinary skill in the related arts will readily appreciate, given the contents of the present disclosure, that the various principles described herein may be more broadly extended to any higher order kernel (e.g., a four-layer kernel, five-layer kernel, etc.)

Even though the two-layer and three-layer kernels are mathematically identical, the selection of kernel structure has significant implementation and/or practical considerations. As previously noted, each neuron 202 receives and/or generates a continuous signal representing its corresponding spiking rate. In the two-layer kernel, the first ensemble is directly connected to the second ensemble. In contrast, the three-layer kernel interposes an intermediate summation stage 204. During three-layer kernel operation, the first ensemble updates the intermediate summation stage 204, and the intermediate summation stage 204 updates the second ensemble. The kernel structure determines the number of values to store in memory, the number of reads from memory for each update, and the number of mathematical operations for each update.

Each neuron 202 has an associated value that is stored in memory, and each intermediary stage 204 has a corresponding value that is stored in memory. For example, in the illustrated two-layer kernel network 200 there are four (4) neurons 202A connected to four (4) neurons 202B, resulting in sixteen (16) distinct connections that require memory storage. Similarly, the three-layer kernel has four (4) neurons 202A connected to two (2) intermediate summation stages 204, which are connected to four (4) neurons 202B, also resulting in sixteen (16) distinct connections that require memory storage.

The total number of neurons 202 (N) and the total number of intermediary stages 204 (D) that are implemented directly correspond to memory reads and mathematical operations. For example, as shown in the two-layer kernel 200, a signal generated by a single neuron 202 results in updates to N distinct connections. Specifically, an inner product is calculated, which corresponds to N separate read and multiply-accumulate operations. Thus, the inner product results in N reads and N multiply-accumulates.

For a three-layer kernel 210 of FIG. 2A, a signal generated by a single neuron 202 results in D updates to the intermediary stages 204, and N×D inner products between the intermediary stages 204 and the recipient neurons 202. Retrieving the first vector associated with the intermediary stages 204 is D reads, and the N vectors associated with the second ensemble is N×D reads. Calculating the N inner-products require N×D multiplications and additions. Consequently, the three-layer kernel 210 suffers a D-fold penalty in memory reads (communication) and multiplications (computation) because inner-products are computed between each of the second ensemble's N encoding vectors and the vector formed by the D intermediary stages updated the first ensemble.

As illustrated within FIG. 2A, the penalties associated with three-layer kernel implementations are substantial. Consequently, existing implementations of neural networks typically rely on the “two-layer” implementation. More directly, existing implementations of neural networks do not experience any improvements to operation by adding additional layers during operation, and actually suffer certain penalties.

### Heterogeneous Neuron Programming Frameworks—

Heterogeneous neuron programming is necessary to emulate the natural diversity present in biological and analog-hardware neurons (e.g., both vary widely in behavior and characteristics). The Neural Engineering Framework (NEF) is one exemplary theoretical framework for computing with heterogeneous neurons. Various implementations of the NEF have been successfully used to model visual attention, inductive reasoning, reinforcement learning, and many other tasks. One commonly used open-source implementation of the NEF is Neural Engineering Objects (NENGO), although other implementations of the NEF may be substituted with equivalent success by those of ordinary skill in the related arts given the contents of the present disclosure.

As previously noted, existing neural networks individually program each idealized neuron with various parameters to create different behaviors. However, such granularity is generally impractical to be manually configured for large scale systems. The NEF allows a human programmer to describe the various desired functionality at a comprehensible level of abstraction. In other words, the NEF is functionally analogous to a compiler for neuromorphic systems. Within the context of the NEF, complex computations can be mapped to a population of neurons in much the same way that a compiler implements high-level software code with a series of software primitives.

As a brief aside, the NEF enables a human programmer to define and manipulate input/output data structures in the “problem space” (also referred to as the “user space”); these data structures are at a level of abstraction that ignores the eventual implementation within native hardware components. However, a neuromorphic processor cannot directly represent problem space data structures (e.g., floating point numbers, integers, multiple-bit values, etc.); instead, the problem space vectors must be synthesized to the “native space” data structures. Specifically, input data structures must be converted into native space computational primitives, and native space computational outputs must be converted back to problem space output data structures.

In one such implementation of the NEF, a desired computation may be decomposed into a system of sub-computations that are functionally cascaded or otherwise coupled together. Each sub-computation is assigned to a single group of neurons (a “pool”). A pool's activity encodes the input signal as spike trains. This encoding is accomplished by giving each neuron of the pool a “preferred direction” in a multi-dimensional input space specified by an encoding vector. As used herein, the term “preferred direction” refers to directions in the input space where a neuron's activity is maximal (i.e., directions aligned with the encoding vector assigned to that neuron). In other words, the encoding vector defines a neuron's preferred direction in a multi-dimensional input space. A neuron is excited (e.g., receives positive current) when the input vector's direction “points” in the preferred direction of the encoding vector; similarly, a neuron is inhibited (e.g., receives negative current) when the input vector points away from the neuron's preferred direction.

Given a varied selection of encoding vectors and a sufficiently large pool of neurons, the neurons' non-linear responses can form a basis set for approximating arbitrary multi-dimensional functions of the input space by computing a weighted sum of the responses (e.g., as a linear decoding). For example, FIG. 2B illustrates three (3) exemplary approximations 220, 230, and 240 of a mathematical signal (i.e., y=sin (π x)+1))/2) being represented as a function of neuron firing rates (i.e., ŷ=Ad). As shown therein, each column of the encoding matrix A represents a single neuron's firing rates over an input range. The function ŷ is shown as a linear combination of different populations of neurons (e.g., 3, 10, and 20). In other words, a multi-dimensional input may be projected by the encoder into a higher-dimensional space (e.g., the aggregated body of neuron non-linear responses has many more dimensions than the input vector), passed through the aggregated body of neurons' non-linear responses, and then projected by a decoder into another multi-dimensional space.

Consider an illustrative example of a robot that moves within three-dimensional (3D) space. The input problem space could be the location coordinates in 3D space for the robot. In this scenario, for a system of ten (10) neurons and an input space having a cardinality of three (3), the encoding matrix has dimensions 3×10. During operation, the input vector is multiplied by the conversion matrix to generate the native space inputs. In other words, the location coordinates can be translated to inputs for the system of neurons. Once in native space, the neuromorphic processor can process the native space inputs via its native computational primitives.

The decoding matrix enables the neuromorphic processor to translate native space output vectors back into the problem space for subsequent use by the user space. In the foregoing robot in 3D space scenario, the output problem space could be the voltages to drive actuators in 3D space for the robot. For a system of ten (10) neurons and an output space with a cardinality three (3), the conversion matrix would have the dimensions 10×3.

As shown in FIG. 2B, approximation error can be adjusted as a function of neuron population. For example, the first exemplary approximation of y with a pool of three (3) neurons 220 is visibly less accurate than the second approximation of y using ten (10) neurons 230. However, increasing the order of the projection eventually reaches a point of diminishing returns; for example, the third approximation of y using twenty (20) neurons 240 is not substantially better than the second approximation 230. More generally, artisans of ordinary skill in the related arts will readily appreciate that more neurons (e.g., 20) can be used to achieve higher precision, whereas fewer neurons (e.g., 3) may be used where lower precision is acceptable.

The aforementioned technique can additionally be performed recursively and/or hierarchically. For example, recurrently connecting the output of a pool to its input can be used to model arbitrary multidimensional non-linear dynamic systems with a single pool. Similarly, large network graphs can be created by connecting the output of decoders to the inputs of other decoders. In some cases, linear transforms may additionally be interspersed between decoders and encoders.

Within the context of NEF based computations, errors can arise from either: (i) poor function approximation due to inadequate basis functions (e.g., using too small of a population of neurons) and/or (ii) spurious spike coincidences (e.g., Poisson noise). As demonstrated in FIG. 2B, function approximation can be improved when there are more neurons allocated to each pool. Similarly, function approximation is made more difficult as the dimensionality of input space increases. Consequently, one common technique for higher order approximation of multi-dimensional input vectors is to “cascade” or couple several smaller stages together. In doing so, a multi-dimensional input space is factored into several fewer-dimensional functions before mapping to pools.

Spurious spiking coincidences (e.g., Poisson noise) is a function of a synaptic time constant and the neurons' spike rates; Poisson noise is a discrete probability distribution that expresses the probability of a given number of events occurring in a fixed interval of time or space when the events occur with a constant rate and independently of the time since the last event. Specifically, Poisson noise is reduced with longer synaptic time constants. However, cascading stages with long synaptic time constants results in longer computational time.

Artisans of ordinary skill in the related arts will readily appreciate given the foregoing discussion that the foregoing techniques (cascaded factoring and longer synaptic time constants) are in conflict for high-dimensional functions with latency constraints. In other words, factoring may improve approximation, but spike noise will increase if the synaptic time-constant must be reduced so as to fit within a specific latency.

Incipient research is directed to further improving neuromorphic computing with mixed-signal hardware when used in conjunction with heterogeneous neuron programming frameworks described herein. For example, rather than using an “all-digital” network that is individually programmed with various parameters to create different behaviors, a “mixed-signal” network advantageously could treat the practical heterogeneity of real-world components as desirable sources of diversity. For example, transistor mismatch and temperature sensitivity could be used to provide an inherent variety of basis functions.

### Exemplary Apparatus—

Various aspects of the present disclosure are presented in greater detail hereinafter. Specifically, methods and apparatus for spiking neural network computing based on e.g., a multi-layer kernel architecture, shared dendritic encoding, and/or thresholding of accumulated spiking signals are disclosed in greater detail hereinafter.

In one exemplary aspect, digital communication is sparsely distributed in space (spatial sparsity) and/or time (temporal sparsity) to efficiently encode and decode signaling within a mixed analog-digital substrate.

In one exemplary embodiment, temporal sparsity may be achieved by combining weighted spike (“delta”) trains via a thresholding accumulator. The thresholding accumulator reduces the total number of delta transactions that propagate through subsequent layers of the kernels. Various disclosed embodiments are able to achieve the same and/or acceptable levels of signal-to-noise ratio (SNR) at a lower output rate than existing techniques.

In another exemplary embodiment, spatial sparsity may be achieved by representing encoders as a sparse set of digitally programmed locations in an array of analog neurons. In one exemplary implementation, the array of analog neurons is a two-dimensional (2D) array and the sparse set of locations are distributed (tap-points) within the array; where each tap-point is characterized by a particular preferred direction. In one such implementation, neurons in the 2D array receive input from the tap-points through a “diffuser” (e.g., a transistor-based implementation of a resistive mesh). Functionally, the diffuser array performs a mathematical convolution via analog circuitry (e.g., resistances).

As used in the present context, the term “sparse” and “sparsity” refer to a dimensional distribution that skips elements of and/or adds null elements to a set. While the present disclosure is primarily directed to sparsity in temporal or spatial dimensions, artisans of ordinary skill in the related arts will readily appreciate that other schemes for adding sparsity may be substituted with equivalent success, including within other dimensions or spaces.

In still another exemplary embodiment, a heterogeneous neuron programming framework can leverage temporal and/or spatial (or other) sparsity within the context of a cascaded multi-layer kernel to provide energy-efficient computations heretofore unrealizable.

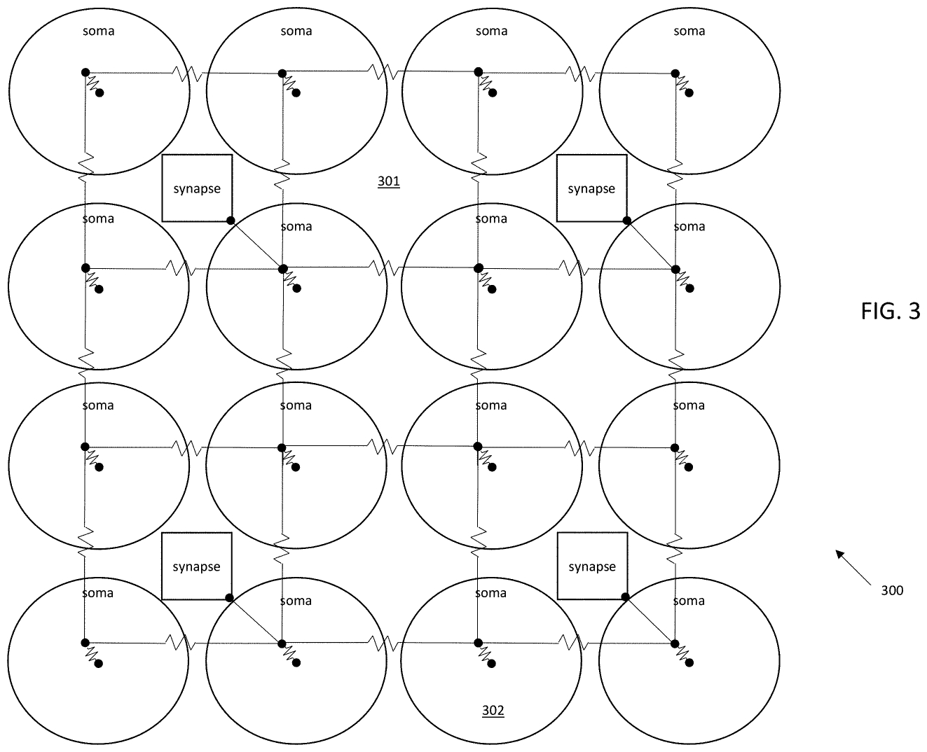

FIG. 3 is a graphical representation of one exemplary embodiment of a spiking neural network 300, in accordance with the various principles described herein. As shown therein, the exemplary spiking neural network comprises a tessellated processing fabric composed of “somas”, “synapses”, and “diffusers” (represented by a network of “resistors”). As shown therein, each “tile” 301 of the tessellated processing fabric includes four (4) somas 302 that are connected to a common synapse; each synapse is connected to the other somas via the diffuser.

While the illustrated embodiment, is shown with a specific tessellation and/or combination of elements, artisans of ordinary skill in the related arts given the contents of the present disclosure will readily appreciate that other tessellations and/or combinations may be substituted. For example, other implementations may use a 1:1 (direct), 2:1 or 1:2 (paired), 3:1 or 1:3, and/or any other N:M mapping of somas to synapses. Similarly, while the present diffuser is shown with a “square” grid, other polygon-based connectivity may be used with equivalent success (e.g., triangular, rectangular, pentagonal, hexagonal, and/or any combination of polygons (e.g., hexagons and pentagons in a “soccer ball” patterning)), or yet other complex shapes or patterns.

Additionally, while the processing fabric 300 of FIG. 3 is a two-dimensional tessellated pattern of repeating geometric configuration, artisans of ordinary skill in the related arts given the contents of the present disclosure will readily appreciate that tessellated, non-tessellated and/or irregular layering in any number of dimensions may be substituted with equivalent success. For example, neuromorphic fabrics may be constructed by layering multiple two-layer fabrics into a three-dimensional construction. Moreover, nonplanar structures or configurations can be utilized, such as where a 2D layer is deformed or “wrapped” into a 3D shape (whether open or closed).

In one exemplary embodiment, a “soma” includes one or more analog circuits that are configured to generate spike signaling based on a value. In one such exemplary variant, the value is represented by an electrical current. In one exemplary implementation, the soma is configured to receive a first value that corresponds to a specific input spiking rate, and/or to generate a second value that corresponds to a specific output spiking rate. In some such variants, the first and second value are integer values, although they may be portions or fractional values.

In one exemplary embodiment, the input spiking rate and output spiking rate is based on a dynamically configurable relationship. For example, the dynamically configurable relationship may be based on one or more mathematical models of biological neurons that can be configured at runtime, and/or during runtime. In other embodiments, the input spiking rate and output spiking rate is based on a fixed or predetermined relationship. For example, the fixed relationship may be part of a hardened configuration (e.g., so as to implement known functionality).

In one exemplary embodiment, a “soma” includes one or more analog-to-digital conversion (ADC) components or logic configured to generate spiking signaling within a digital domain based on one or more values. In one exemplary embodiment, the soma generates spike signaling having a frequency that is directly based on one or more values provided by a synapse. In other embodiments, the soma generates spike signaling having a pulse density that is directly based on one or more values provided by a synapse. Still other embodiments may utilize generation of spike signaling having a pulse width, pulse amplitude, or any number of other spike signaling techniques.

In one exemplary embodiment, a “synapse” includes one or more digital-to-analog conversion (DAC) components or logic configured to convert spiking signaling in the digital domain into one or more values (e.g., current) in the analog domain. In one exemplary embodiment, the synapse receives spike signaling having a frequency that is converted into a one or more current signals that can be provided to a soma. In other embodiments, the synapse may convert spike signaling having a pulse density, pulse width, pulse amplitude, or any number of other spike signaling techniques into the aforementioned values for provision to the soma.

In one exemplary embodiment, the ADC and/or DAC conversion between spiking rates and values may be based on a dynamically configurable relationship. For example, the dynamically configurable relationship may enable spiking rates to be accentuated or attenuated. More directly, in some configurations, a synapse may be dynamically configured to receive/generate a greater or fewer number of spikes corresponding to the range of values used by the soma. In other words, the synapse may emulate a more or less sensitive connectivity between somas. In other embodiments, the ADC and/or DAC conversion is a fixed configuration. In yet other embodiments, a plurality of selectable predetermined discrete values of “sensitivity” are utilized.

In one exemplary embodiment, a “diffuser” includes one or more diffusion elements that couple each synapse to one or more somas and/or synapses. In one exemplary variant, the diffusion elements are characterized by resistance that attenuates values (current) as a function of spatial separation. In other variants, the diffusion elements may be characterized by active components that actively amplify signal values (current) as a function of spatial separation. While the foregoing diffuser is presented within the context of spatial separation, artisans of ordinary skill in the related arts will appreciate, given the contents of the present disclosure, that other parameters may be substituted with equivalent success. For example, the diffuser may attenuate/amplify signals based on temporal separation, parametric separation, and/or any number of other schemes.

In one exemplary embodiment, the diffuser comprises one or more transistors which can be actively biased to increase or decrease their pass through conductance. In some cases, the transistors may be entirely enabled or disabled so as to isolate (cut-off) one synapse from another synapse or soma. In one exemplary variant, the entire diffuser fabric is biased with a common bias voltage. In other variants, various portions of the diffuser fabric may be selectively biased with different voltages. Artisans of ordinary skill in the related arts given the contents of the present disclosure will readily appreciate that other active components may be substituted with equivalent success; other common examples of active components include without limitation e.g.: diodes, memristors, field effect transistors (FET), and bi-polar junction transistors (BJT).

In other embodiments, the diffuser comprises one or more passive components that have a fixed or characterized impedance. Common examples of such passive components include without limitation e.g., resistors, capacitors, and/or inductors. Moreover, various other implementations may be based on a hybrid configuration of active and passive components. For example, some implementations may use resistive networks to reduce overall cost, with some interspersed MOSFETs to selectively isolate portions of the diffuser from other portions.

### Exemplary Reduced Rank Operation—

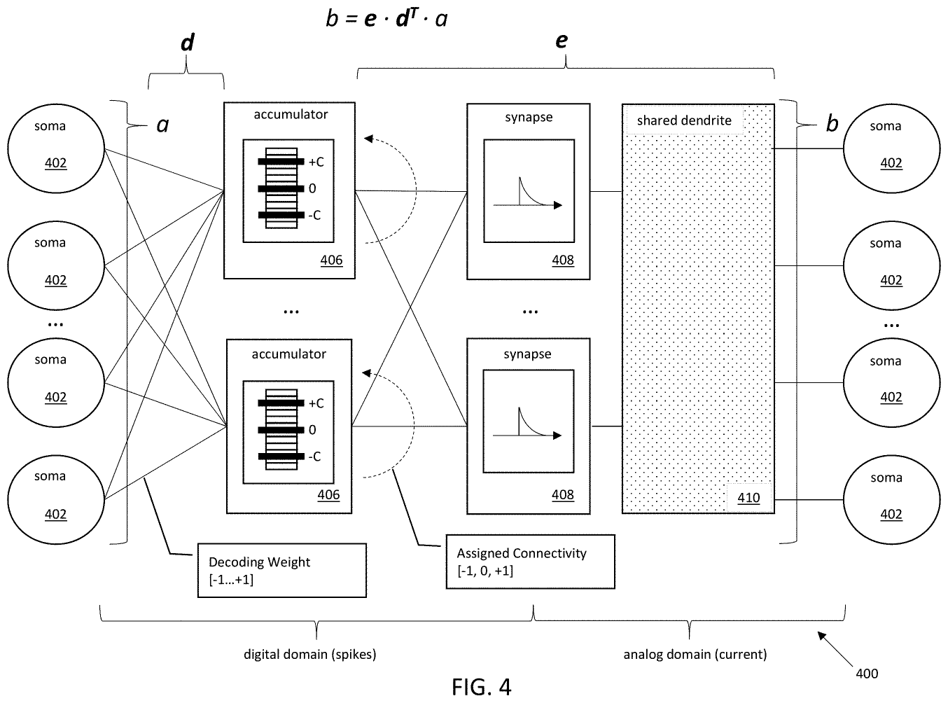

Referring now to FIG. 4, a logical block diagram of one exemplary embodiment of a spiking neural network characterized by a reduced rank structure is illustrated. While the logical block diagram is shown with signal flow from left-to-right, the flow is purely illustrative; in some implementations, for example, the spiking signaling may return to its originating ensemble and/or soma (i.e., wrap-around).

In one exemplary embodiment, the spiking neural network 400 includes a digital computing substrate that combines somas 402 emulating spiking neuron functionality with synapses 408 that generate currents for distribution via an analog diffuser 410 (shared dendritic network) to other somas 402. As described in greater detail herein, the combined analog-digital computing substrate advantageously enables, inter alia, the synthesis of spiking neural nets of unprecedented scale.

In one exemplary embodiment, computations are mapped onto the spiking neural network 400 by using an exemplary Neural Engineering Framework (NEF) synthesis tool. During operation, the NEF synthesis assigns encoding and decoding vectors to various ensembles. As previously noted, encoding vectors define how a vector of continuous signals is encoded into an ensemble's spiking activity. Decoding vectors define how a mathematical transformation of the vector is decoded from an ensemble's spiking activity. This transformation may be performed in a single step by combining decoding and encoding vectors to obtain synaptic weights that connect one ensemble directly to another and/or back to itself (for a dynamic transformation). This transformation may also be performed in multiple steps according to the aforementioned factoring property of matrix operations.

The illustrated mixed analog-digital substrate of FIG. 4 performs the mathematical functionality of a three-layer kernel, with first-to-second and second-to-third layer weights defined by decoding vectors (d) and encoding vectors (e), respectively. As previously noted, a three-layer kernel suffers from significant penalties under an “all-digital” software implementation, however the mixed analog-digital substrate of FIG. 4 leverages the benefits of thresholding accumulators 406 and the shared dendrite diffuser 410 to cut memory, computation, and communication resources by an order-of-magnitude. These advantages enable implementations of spiking neural networks with millions of neurons and billions of synaptic connections in real-time using milliwatts of power.

In one exemplary embodiment, a transformation of a vector of continuous signals is decoded from an ensemble's spike activity by weighting a decoding vector (d) assigned to each soma 402 by its spike rate value and summing the results across the ensemble. This operation is performed in the digital domain on spiking inputs to the thresholding accumulators 406. The resulting vector is assigned connectivity to one or more synapses 408, and encoded for the next ensemble's spike activity by taking the resulting vector's inner-product with encoding vectors (e) assigned to that ensemble's neurons via the assigned connectivity. As previously noted, the decoding and encoding operations result in a mathematical kernel with three layers. Specifically, the decoding vectors define weights between the first and the second layers (the somas 402 and the thresholding accumulators 406) while encoding tap-weights define connectivity between the second and third layers (the synapses 408 and the shared dendrite 410).

In one exemplary embodiment, the decoding weights are granular weights which may take on a range of values. For example, decoding weights may be chosen or assigned from a range of values. In one such implementation, the range of values may span positive and negative ranges. In one exemplary variant, the decoding weights are assigned to values within the range of +1 to −1.

In one exemplary embodiment, connectivity is assigned between the accumulator(s) 406 and the synapse(s) 408. In one exemplary variant, connectivity may be excitatory (+1), not present (0), or inhibitory (−1). Various other implementations may use other schemes, including e.g., ranges of values, fuzzy logic values (e.g., “on”, “neutral” “off”), etc. Other schemes for decoding and/or connectivity will be readily appreciated by artisans of ordinary skill given the contents of the present disclosure.

In one exemplary embodiment, decoding vectors are chosen to closely approximate the desired transformation by minimizing an error metric. For example, one such metric may include e.g., the mean squared-error (MSE). Other embodiments may choose decoding vectors based on one or more of a number of other considerations including without limitation: accuracy, power consumption, memory consumption, computational complexity, structural complexity, and/or any number of other practical considerations.

In one exemplary embodiment, encoding vectors may be chosen randomly from a uniform distribution on the D-dimensional unit hypersphere's surface. In other embodiments, encoding vectors may be assigned based on specific properties and/or connectivity considerations. For example, certain encoding vectors may be selected based on known properties of the shared dendritic fabric. Artisans of ordinary skill in the related arts will readily appreciate given the contents of the present disclosure that decoding and encoding vectors may be chosen based on a variety of other considerations including without limitation e.g.: desired error rates, distribution topologies, power consumption, processing complexity, spatial topology, and/or any number of other design specific considerations.

Under existing technologies, a two-layer kernel's memory-cell count exceeds a three-layer kernel's by a factor of ½N/D (i.e., half the number of neurons (N) divided by the number of continuous signals (D)). However, an all-digital three-layer kernel implements more memory reads (communication) and multiplications (computation) by a factor of D. In contrast, the reduced rank structure of the exemplary spiking neural network 400 does not suffer the same penalties of an all-digital three-layer kernel because the thresholding accumulators 406 can reduce downstream operations without a substantial loss in fidelity (e.g., SNR). In one exemplary embodiment, the thresholding accumulators 406 reduce downstream operations by a factor equal to the average number of spikes required to trip the accumulator. Unlike a non-thresholding accumulator that updates its output with each incoming spike, the exemplary thresholding accumulator's output is only updated after multiple spikes are received. In one such exemplary variant, the average number of input spikes required to trigger an output (k), is selected to balance a loss in SNR of the corresponding continuous signal in the decoded vector, with a corresponding reduction in memory reads.

As a brief aside, several dozen neurons are needed to represent each continuous signal (N/D). The exact number depends on the desired amplitude precision and temporal resolution. For example, representing a continuous signal with 28.3 SNR (signal-to-noise ratio) at a temporal resolution of 100 milliseconds (ms) requires thirty two (32) neurons firing at 125 spikes per second (spike/s) (assuming that each neuron fires independently and that their corresponding decoding vectors' components have similar amplitudes).

Consider a scenario where the incoming point process (e.g., the spike train to be accumulated) obeys a Poisson distribution and the outgoing spike train obeys a Gamma distribution. The SNR (r λ/σ) of a Poisson point process filtered by an exponentially decaying synapse is rₚₒᵢ=√(2τ_{syn}λₚₒᵢ), where τ_{syn} is the synaptic time-constant and λₚₒᵢ is the mean spike rate. Feeding this point process to the thresholding accumulator yields a Gamma point process with r_{gam}≈rₚₒᵢ/√(1+k²/3rₚₒᵢ²), after it is exponentially filtered (assuming rₚₒᵢ²>>1 and k²>>1). Thus, the SNR deteriorates negligibly if rₚₒᵢ>>k. Under such circumstances, the number of downstream operations may be minimized by setting the thresholding accumulator's 406 threshold to a value that offsets the drops in SNR by the reduction in traffic. In one exemplary embodiment, k can be selected such that the average number of spikes required to trip it is k=(4r)^{2/3}, where r is the desired SNR. The desired SNR of 28.3 can be achieved by setting k=23.4; this threshold effectively cuts the accumulator updates 19.7-fold without any deterioration in SNR. Other variants may use more or less aggressive values of k in view of the foregoing trade-offs.

Referring back to FIG. 4, replacing the memory crossbars (used for memory accesses in traditional software based spiking networks) with shared dendrites 410 can eliminate memory cells (and corresponding reads) as well as multiply-accumulate operations. Specifically, two-layer kernels store N² synaptic weights (a full rank matrix of synaptic weights) and every spiking event requires a read of N synaptic weights (corresponding to the connections to N neurons).

In contrast, the shared dendrite 410 provides weighting within the analog domain as a function of spatial distance. In other words, rather than encoding synaptic weights, the NEF assigns spatial locations that are weighted relative to one another as a function of the shared dendrite 410 resistances. Replacing encoding vectors with dimension-to-tap-point assignments (spatial location assignments) cuts memory accesses since the weights are a function of the physical location within the shared dendrite. Similarly, the resistance loss is a physical feature of the shared dendrite resistance. Thus, no memory is required to store encoding weights, no memory reads are required to retrieve these weights, and no multiply-accumulate operations are required to calculate inner-products. When compared with the two-layer kernel's hardware, memory words are cut by a factor of N²/(D(N+T))≈N/D, where T is the number of tap-points per dimension since T<<N. When used in conjunction with the aforementioned thresholding accumulator 406 (and its associated k-fold event-rate drop), memory reads are cut by a factor of (N/D)/(1+T/k).

Furthermore, instead of performing N×D multiplications and additions for inner product calculations, each of D accumulator values is simply copied to each of the T tap-points assigned to that particular dimension.

While the foregoing discussion is presented within the context of a reduced rank spiking network 400 that combines digital threshold accumulators 406 to provide temporal sparsity and analog diffusers 410 to provide spatial sparsity, artisans of ordinary skill in the related arts will readily appreciate given the contents of the present disclosure that a variety of other substitutions and/or modifications may be made with equivalent success. For example, the various techniques described therein may be combined with singular value decomposition (SVD) to compress matrices with less than full rank; for example, a synaptic weight matrix (e.g., between adjacent layers of a deep neural network) may be transformed into an equivalent set of encoding and decoding vectors. Using these vectors, a two-layer kernel may be mapped onto a reduced rank implementation that uses less memory for weight storage.

Exemplary Encoding of Preferred Directions within a Shared Dendrite—

Referring now to the shared dendritic operation, various aspects of the present disclosure leverage the inherent redundancy of the encoding process by using the analog diffuser to efficiently fan out and mix outputs from a spatially sparse set of tap-points, rather than via parameterized weighting. As previously alluded to, the greatest fan out takes place during encoding because the encoders form an over-complete basis for the input space. Implementing this fan out within parameterized weighting is computationally expensive and/or difficult to achieve via traditional paradigms. Specifically, the encoding process for all-digital networks required memory to store weighting definitions for each encoding vector. In order to encode stimulus for an ensemble's neurons, prior art neural networks calculated a D-dimensional stimulus vector's inner-product with each of the N D-dimensional encoding vectors assigned to the ensemble's neurons. Performing the inner-product calculation within the digital domain disadvantageously requires memory, communication and computation resources to store N×D vector components, read the N×D words from memory, and perform N×D multiplications and/or additions.

In contrast, the various embodiments described throughout use tap-points that are sparsely distributed in physical location within the analog diffuser. This provides substantial benefits because, inter alia, each neuron's resulting encoder is a physical property of the diffuser's summation of the “anchor encoders” of nearby tap-points, modulated by an attenuation (weight) dependent on the neuron's physical distance to those tap-points. Using this approach, it is possible to assign varied encoders to all neurons without specifying and implementing each one with digital parameterized weights. Additionally, encoding weights may be implemented via a semi-static spatial assignment of the diffuser (a location); thus, encoding weights are not retrieved via memory accesses.

As previously noted, the encoding vectors (i.e., preferred directions) should be greater than the input dimension to preserve precision. However, higher order spaces can be factored and cascaded from substantially lower order input. Consequently, in one exemplary embodiment, higher order input is factored such that the resulting input has sufficiently low dimension to be encoded with a tractable number of tap-points (e.g., 10, 20, etc.) to achieve a uniform encoder distribution. In one exemplary embodiment, anchor encoders are selected to be standard-basis vectors that take advantage of the sparse encode operation. Alternatively, in some embodiments, anchor encoders may be assigned arbitrarily e.g., by using an additional transform.

As a brief aside, any projection in D-dimensional space can be minimally represented with D orthogonal vectors. Multiple additional vectors may be used to represent non-linear and/or higher order stimulus behaviors. Within the context of neural network computing, encoding vectors are typically chosen randomly from a uniform distribution on a D-dimensional unit hypersphere's surface as the number of neurons in the ensemble (N) greatly exceeds the number of continuous signals (D) it encodes.

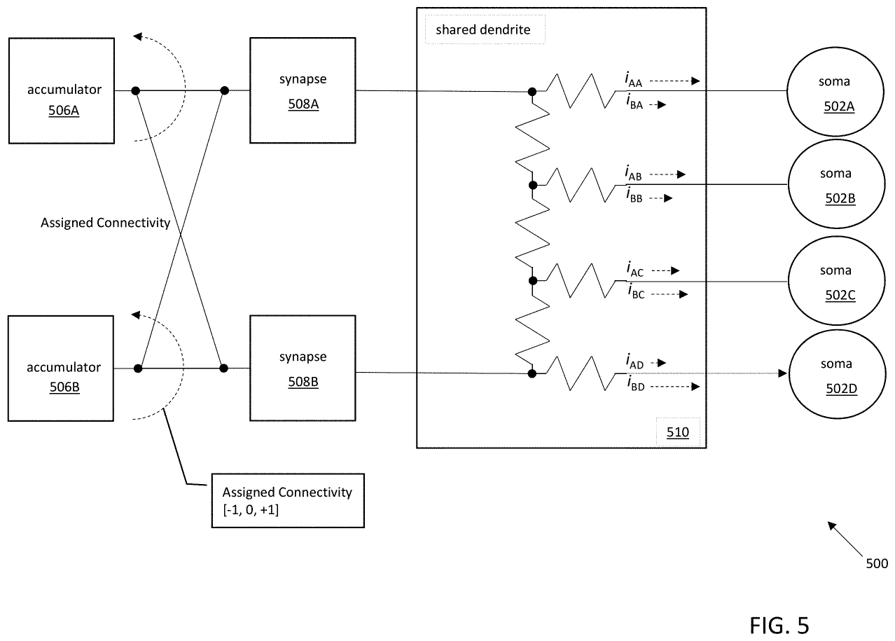

Referring now to FIG. 5, various aspects of the present disclosure are directed to encoding spiking stimulus to various ensembles via a shared dendrite; a logical block diagram 500 of one simplified shared dendrite embodiment is presented. While a simplified shared dendrite is depicted for clarity, various exemplary implementations of the shared dendrite may be implemented by repeating the foregoing structure as portions of the tessellated fabric. As shown there, the exemplary embodiment of the shared dendrite represents encoding weights within spatial dimensions. By replacing encoding vectors with an assignment of dimensions to tap-points, shared dendrites cut the encoding process' memory, communication and computation resources by an order-of-magnitude.

As used herein, the term “tap-points” refers to spatial locations on the diffuser (e.g., a resistive grid emulated with transistors where currents proportional to the stimulus vector's components are injected). This diffuser communicates signals locally while scaling them with an exponentially decaying spatial profile.

In the case of standard-basis anchor vectors, the amplitude of the component (e) of a neuron's encoding vector is determined by its distances from the T tap-points assigned to the corresponding dimension. For example, synapse 508A has distinct paths to soma 502A and soma 502B, etc., each characterized by different resistances and corresponding magnitudes of currents (e.g., i_{AA}, i_{AB}, etc.) Similarly, synapse 502B has distinct paths to soma 502A and soma 502B, etc., and corresponding magnitudes of currents (e.g., i_{BA}, i_{BB}, etc.) By attenuating synaptic spikes with resistances in the analog domain (rather than calculating inner-products in the digital domain), the shared dendrite eliminates N×D multiplications entirely, and memory reads drop by a factor of N/T. For a network of 256 neurons (N=256), and 8 tap-points (T=8), the corresponding reduction in memory reads is 32-fold.

In one embodiment, randomly assigning a large numbers of tap-points per dimension can yield encoding vectors that are fairly uniformly distributed on the hypersphere for ensembles. In other embodiments, selectively (non-randomly) assigning a smaller number of tap-points per dimension may be preferable where uniform distribution is undesirable or unnecessary; for example, selective assignments may be used to create a particular spatial or functional distribution. More generally, while the foregoing shared dendrite uses randomly assigned tap-points, more sophisticated strategies can be used to assign dimensions to tap-point location. Such strategies can be used to optimize the distribution of encoding vector directions for specific computations, minimize placement complexity, and/or vary encoding performances. Depending on configuration of the underlying grid (e.g., capacity for reconfigurability), these assignments may also be dynamic in nature.

In one exemplary variant, the dimension-to-tap-point assignment includes assigning a connectivity for different tap-points for the current. For example, as shown therein, accumulators 506A and 506B can be assigned to connect to various synapses e.g., 508A, 508B. In some cases, the assignments may be split evenly between positive currents (source) and negative currents (sink). In other words, positive currents may be assigned to a different spatial location than negative currents. In other variants, positive and negative currents may be represented within a single synapse.

In one exemplary embodiment, a diffuser is a resistive mesh implemented with transistors that sits between the synapse's outputs and the soma's inputs, spreading each synapse's output currents among nearby neurons according to their physical distance from the synapse. In one such variant, the space-constant of this kernel is tunable by adjusting the gate biases of the transistors that form the mesh. Nominally, the diffuser implements a convolutional kernel on the synapse outputs, and projects the results to the neuron inputs.

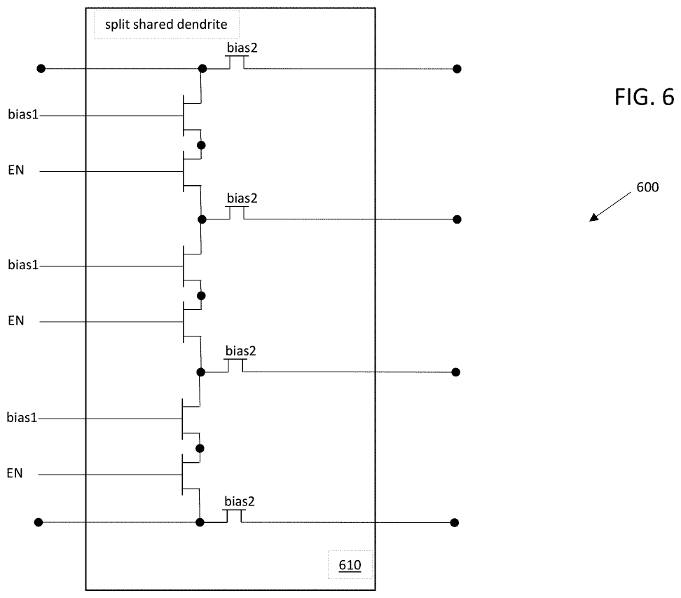

Referring now to FIG. 6, one logical block diagram of an exemplary embodiment of a shared dendrite 610 characterized by a dynamically partitioned structure 600 is presented. In one exemplary embodiment, the dendritic fabric enables three (3) distinct transistor functions. As shown therein, one set of transistors has a first and second configurable bias point, thereby imparting variable resistive/capacitive effects on the output spike trains.

In one exemplary embodiment, the first biases may be selected to attenuate signal propagation as a function of distance from the various tap-points. By increasing the first bias, signals farther away from the originating synapse will experience more attenuation. In contrast, by decreasing the first bias, a single synapse can affect a much larger group of somas.

In one exemplary embodiment, the second biases may be selected to attenuate the amount of signal propagated to each soma. By increasing the second bias, a stronger signal is required to register as spiking activity; conversely decreasing the second bias results in more sensitivity.

Another set of transistors has a binary enable/disable setting thereby enabling “cuts” in the diffuser grid to subdivide the neural array into multiple logical ensembles. Isolating portions of the diffuser grid can enable a single array to perform multiple distinct computations. Additionally, isolating portions of the diffuser grid can enable the grid to selectively isolate e.g., malfunctioning portions of the grid.

While the illustrated embodiment shows a first and second set of biases, various other embodiments may allow such biases to be individually set or determined. Alternatively, the biases may be communally set. Still other variants of the foregoing will be readily appreciated by those of ordinary skill in the related arts, given the contents of the present disclosure. Similarly, various other techniques for selective enablement of the diffuser grid will be readily appreciated by those of ordinary skill given the contents of the present disclosure.

Furthermore, while the foregoing discussion is presented within the context of a two-dimensional diffuser grid, artisans of ordinary skill in the related arts will readily appreciate given the contents of the present disclosure that a variety of other substitutions and/or modifications may be made with equivalent success. For example, higher order diffuser grids may be substituted by stacking chips using TSVs (through-silicon-vias) to transmit its analog signals between neighboring chips. In some such variants, additional dimensions may result in a more uniform distribution of encoding vectors on a hypersphere without increasing the number of tap-points per dimension.

Exemplary Decoding of Spike Trains with Threshold Accumulators—

As a brief aside, so-called “linear” decoders (commonly used in all-digital neural network implementations) decode a vector's transformation by scaling the decoding vector assigned to each neuron by that neuron's spike rate. The resulting vectors for the entire ensemble are summed. Historically, linear decoders were used because it was easy to find decoding vectors that closely approximate the desired transformation by e.g., minimizing the mean squared-error (MMSE). However, as previously noted, linear decoders currently update the output for each incoming spike; more directly, as neural networks continue to grow in size, linear decoders require exponentially more memory accesses and/or computations.

However, empirical evidence has shown that when neuronal activity is conveyed as spike trains, linear decoding may be performed probabilistically. For example, consider an incoming spike of a spike train that is passed with a probability equal to the corresponding component of its neuron's decoding vector. Probabilistically passing the ensemble's neuron's spike trains results in a point process that is characterized by a rate (r) that is proportionally deprecated relative to the corresponding continuous signal in the transformed vector. Such memory-less schemes produce Poisson point processes, characterized by an SNR (signal-to-noise ratio) that grows only as a square root of the rate (r). In other words, to double the SNR, the rate (r) must be quadrupled (√4=2); by extension, reducing the rate (r) by a factor of four (4) only attenuates SNR by a factor of ½.

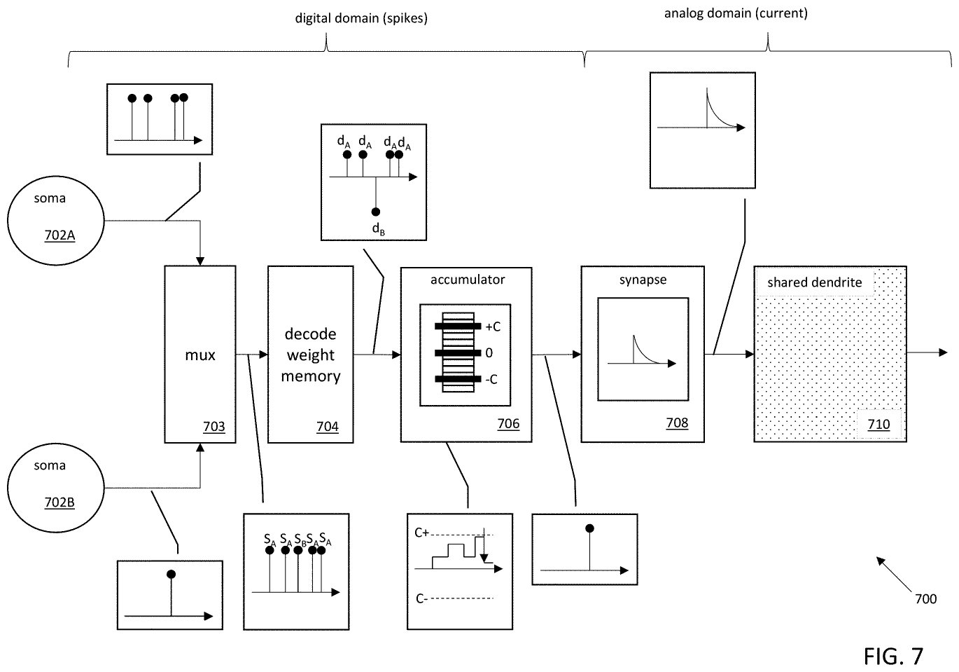

Referring now to FIG. 7, a logical block diagram 700 of one exemplary embodiment of a thresholding accumulator is depicted. As shown, one or more soma 702 are connected to a multiplexer 703 and a decode weight memory 704. As each soma 702 generates spikes, the spikes are multiplexed together by the multiplexor 703 into a spike train that includes origination information (e.g., a spike from soma 702A is identified S_{A}). Decode weights for the spike train are read from the decode weight memory 704 (e.g., a spike from soma 702A is weighted with the corresponding spike value d_{A}). The weighted spike train is then fed to a thresholding accumulator 706 to generate a deprecated set of spikes based on an accumulated spike value.

In slightly more detail, the weighted spike train is accumulated within the thresholding accumulator 706 via addition or subtraction according to weights stored within the decode weight memory 704; once the accumulated value breaches a threshold value (+C or −C), an output spike is generated for transmission via the assigned connectivity to synapses 708 and tap-points within the dendrite 710, and the accumulated value is decremented (or incremented) by the corresponding threshold value. In other variants, when the accumulated value breaches a threshold value, an output spike is generated, and the thresholding accumulator returns to zero.

Replacing a linear decoding summation scheme with the thresholding accumulator as detailed herein greatly reduces traffic and avoids hardware multipliers, while simplifying the analog synapse's circuit design. Specifically, the thresholding accumulator sums the rates of deltas instead of superposing them. Accumulation is functionally equivalent to linear decoding via summation, since the NEF encodes the values of delta trains by their filtered rates. However, rather than using multilevel inputs which require a digital-to-analog (DAC) converter that can be costly in terms of area, exemplary embodiments use accumulator deltas that are unit-area deltas with signs denoting excitatory and inhibitory inputs (e.g., +1, −1). In this manner, streams of variable-area deltas generated from somas 702 can be converted back to a stream of unit-area deltas before being delivered to the synapses 708 via the accumulator 706. Operating on delta rates restricts the areas of each delta in the accumulator's output train to be +1 or −1 and encoding value with modulation of only the rate and sign of the outputs. More directly, information is conveyed via a rate and sign, rather than by signal value (which require multiply-accumulates to process.)

For the usual case of weights smaller than one (1), the accumulator produces a lower-rate output stream, reducing traffic compared to the superposition techniques of linear decoding. As previously alluded to, linear decoding conserves spikes from input to output. Thus, O(Dᵢₙ) deltas entering a Dᵢₙ×Dₒᵤₜ matrix will result in O(Dᵢₙ×Dₒᵤₜ) deltas being output. This multiplication of traffic compounds with each additional weight matrix layer. For example, a N-D-D-N cascading architecture performs a cascaded decode-transform-encode such that O(N) deltas from the neurons results in O(N²D²) deltas delivered to the synapses. In contrast, the exemplary inventive accumulator yields O(N×D) deltas to the synapses of the equivalent network.

In one exemplary embodiment, the thresholding accumulator 706 is implemented digitally for decoding vector components (stored digitally). In one such variant, the decoding vector components are eight (8) bit integer values. In other embodiments, the thresholding accumulator 706 may be implemented in analog via other storage type devices (e.g., capacitors, inductors, memristors, etc.)

In one exemplary embodiment, the accumulator's threshold (C) determines the number of incoming spikes (k) required to trigger an outgoing spike event. In one such variant, C is selected to significantly reduce downstream traffic and associated memory reads.

Mechanistically, the accumulator 706 operates as a deterministic thinning process that yields less noisy outputs than prior probabilistic approaches for combining weighted streams of deltas. The accumulator decimates the input delta train to produce its outputs, performing the desired weighting and yielding an output that more efficiently encodes the input, preserving most of the input's SNR while using fewer deltas.

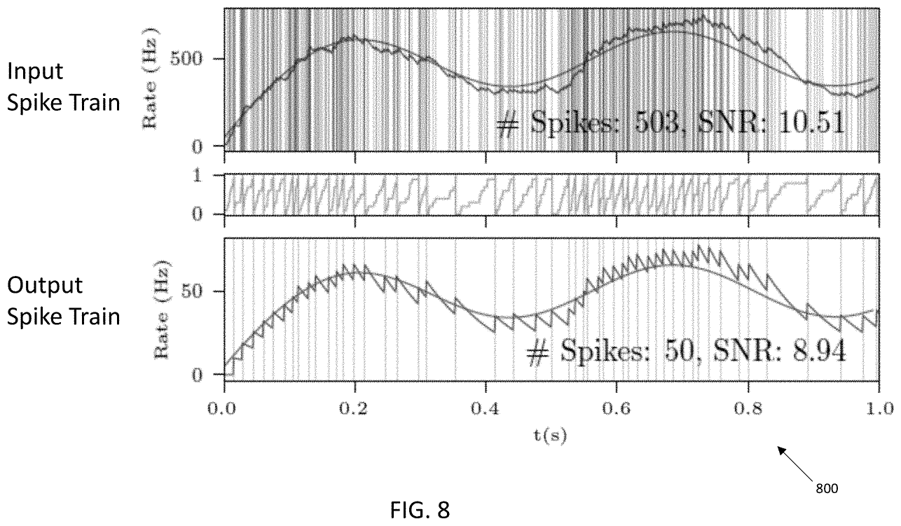

FIG. 8 is a graphical representation 800 of an exemplary input spike train and its corresponding output spike trains for an exemplary thresholding accumulator. As shown therein, the input spike train is generated by an inhomogeneous Poisson process (a smoothed ideal output is also shown in overlay.) The resulting output spikes of the accumulator are decimated with a weighting of 0.1 (as shown 503 spikes are reduced to 50 spikes). While decimation is beneficial, there may be a point where excessive decimation is undesirable due to corresponding losses in a signal-to-noise ratio (SNR). The accumulator's SNR performance can be adjusted by increasing or decreasing decimation rates (SNR=E[X]/√var(X), where X is the filtered waveform). As shown in FIG. 8, a 0.1 rate decimation performs the desired weighting and yields an output that more efficiently encodes the input, while preserving most of the input's SNR (SNR 10.51 versus SNR 8.94) with an order of magnitude fewer deltas.

### Methods for Accumulating Spike Signaling in a Multi-Layer Kernel—

As a brief aside, a traditional processor pipeline has stages that are demarcated by clock cycles (instruction fetch, instruction decode, etc.) During each clock cycle, the output of each stage is sequentially fed as input into the next stage. Asynchronous implementations of neuromorphic processing are not “clocked” per se, but the concept of pipeline-based processing may be useful to illustrate how a multi-layer kernel may be “staged” nonetheless. In particular, a multi-layer kernel may be divided into multiple asynchronous stages of logic or circuitry within the context of a broader sequence of operations.

To better illustrate neuromorphic stage-based operation, consider a two-layer kernel that has a single stage between the two layers. During operation, the input spikes are propagated from the first layer to the second layer without reference to timing; in other words, spike propagation is treated as occurring without timing relationships to one another (asynchronously). In contrast, the aforementioned three-layer kernel has two stages: an encode stage and a decode stage that are separated via an intermediary layer. Input spikes are encoded and accumulated asynchronously, and the accumulated output spikes are decoded asynchronously; however, the encoding stage and decoding stage are ordered sequentially.

While traditional two-layer kernels may benefit from thresholding accumulation, the staging principle described supra may be leveraged to achieve benefits downstream in multi-layer kernel operation. In particular, an intermediary layer of a multi-layer kernel architecture can reduce signaling between neuromorphic processing stages based on threshold accumulation. Splitting neuromorphic processing into stages (e.g., encoding, decoding) enables the multi-layer kernel to isolate and reduce spike signaling rates before propagating signaling to downstream stages. For example, rather than directly propagating spike signaling between layers (e.g., a two-layer kernel), a three-layer kernel can decimate the spiking rates between the first encoding stage and the second decoding stage. If properly tuned, the thresholding accumulator can reduce the output spiking rates to improve overall system performance with minimal performance degradation. These and other features of the present disclosure will be readily apparent to those of ordinary skill in the related arts, given the contents of the present disclosure.

In the previously described exemplary multi-layer kernel implementations, a first processing “stage” handles encoding, and a second stage handles decoding in sequence. It will be appreciated, however, that other more complex configurations may be substituted with equal success. For instance, some multi-layer kernels may support a fewer or greater number of stages (e.g., one stage, three stages, four stages, etc.) Similarly, not all stages of a neuromorphic processor may be linked; e.g., a first layer may feed into both a second and a third layer, each of which operates in parallel. Still other variants may implement a hybridization of the foregoing. It will also be noted that while described primarily herein in terms of a common neuromorphic processor/multi-layer kernel, the disclosure is not so limited; e.g., one stage of one processer/kernel may comprise an input to another stage of a separate processor/kernel

Additionally, while the aforementioned exemplary embodiments describe spiking neural network computing, artisans of ordinary skill in the related arts will, given the contents of the present disclosure, readily appreciate that the principles described herein may be applied to any neuromorphic applications that benefit from threshold accumulation so as to effectuate a desired functionality or characteristic; e.g., reduced power consumption, reduced processing/memory complexity, and/or trade-offs with respect to signal fidelity.

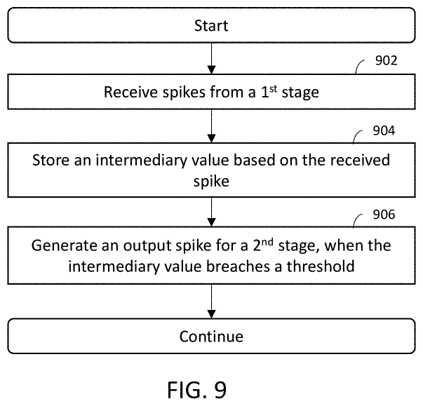

FIG. 9 is a logical flow diagram of one exemplary method for accumulating spiking signaling in a multi-layer kernel architecture. In one exemplary implementation, the mixed-signal neural network implements a multi-layer kernel to synergistically combine the different characteristics of digital and analog domains in mixed-signal processing. Various apparatus and techniques for multi-layer kernel operation are described in greater detail within U.S. patent application Ser. No. ______ filed contemporaneously herewith on Jul. 10, 2019 and entitled “METHODS AND APPARATUS FOR SPIKING NEURAL NETWORK COMPUTING BASED ON A MULTI-LAYER KERNEL ARCHITECTURE”, previously incorporated herein by reference. It will be appreciated, however, that such apparatus and techniques are but one configuration that can be used consistent with the methods and apparatus of the present disclosure.

As a brief aside, “analog domain processing” refers to signal processing that is based on continuous physical values; common examples of continuous physical values are e.g., electrical charge, voltage, and current. For example, synapses generate analog current values that are distributed through a shared dendrite to somas. In contrast, “digital domain processing” refers to signal processing that is performed on symbolic logical values; logical values may include e.g., logic high (“1”) and logic low (“0”). For example, spike signaling in the digital domain uses data packets to represent a spike.

While exemplary embodiments have been described in the context of analog and digital mixed-signal processing, artisans of ordinary skill in the related arts given the contents of the present disclosure will readily appreciate that any number and/or type of domains may be substituted with equal success (including permutation of ordering). For example, a processor may cascade a myriad of digital domains (e.g., a multi-layer kernel that is composed of four (4) or more layers). Still other implementations may use other mixed-signal technologies e.g., electro-mechanical (e.g., piezo electric, surface acoustic wave, etc.) Moreover, while the foregoing discussions are presented in the context of a 2D array, incipient manufacturing technologies may enable more complex dimensions (e.g., 3D, 4D, higher dimensions).

At step 902 of the method 900 of FIG. 9, a thresholding accumulator receives spikes from a first stage of a multi-layer kernel architecture. In one embodiment, a spike is a data packet that includes e.g., an address, and a payload. The address may identify the computational primitive to which that the spike is addressed, or from which the spike is originated. The payload may identify whether or not the spike is excitatory and/or inhibitory. More complex data structures may incorporate other constituent data within the payload. For example, such alternative payloads may include e.g., programming data, formatting information, metadata, error correction data, and/or any other ancillary data.

In one exemplary embodiment, the first stage of the multi-layer kernel architecture corresponds to a “decode stage” that includes a set of somas, multiplexing logic, decode weight memory, and the thresholding accumulator. However, artisans of ordinary skill in the related arts will readily appreciate, given the contents of the present disclosure, that any stage of neuromorphic processing may be substituted with equal success. For example, an “encode stage” may include a set of somas, demultiplexing logic, encode weight memory, and the thresholding accumulator. Still other types of neuromorphic stages may include any combination of multiplexing/demultiplexing logic, somas, synapses, dendrites, memories, analog-to-digital (A/D)/digital-to-analog (D/A) conversion, arithmetic units, and/or any other neuromorphic logic, entity, and/or structure.

As previously noted, a soma may be embodied as a mixed-signal computational primitive that receives current signaling in the analog domain, and generates spike signaling in the digital domain. In contrast, a synapse may be embodied as a mixed-signal computational primitive that receives spikes in the digital domain, and generates current signaling in the analog domain for distribution via a dendrite to somas. Spike-based signaling is generally analogous to edge-based logic; in other words, the spike is present or not present (similar to binary logic high or logic low) and has no timing relative to other spikes. In more complex variants, spike-based signaling may additionally include polarity information (e.g., excitatory or inhibitory). Information may be conveyed either as a spike or a number of spikes (e.g., a spike train); for example, a spike train may be used to convey a spike rate (a number of spikes within a period of time). Notably, the binary and/or signed nature spike signaling is particularly suitable for digital domain processing because of its immunity to noise and arithmetic nature (easily represented as binary and/or signed values).

A memory is one type of non-transitory computer-readable apparatus that can store data and/or instructions. Various embodiments of the present disclosure may use memory to store e.g., spikes (e.g., the data packet in whole or part), parameters relating to spikes (e.g., decode weights, encode weights, connectivity, spatial assignments, etc.), and/or any arithmetic result corresponding thereto. For example, while most neuromorphic applications are robust to error and noise, esoteric implementations may implement e.g., error correction coding, and/or parity type operations.

In one configuration, the memory is a thresholding accumulator that includes logic configured to multiply and accumulate spikes by a corresponding weight. In some embodiments, the assigned weighting is based on decoding weights that approximate a specific target dynamic to within a desired tolerance. In alternative embodiments, the assigned weighting may be based on e.g., encoding weights that provide a sufficient basis set for approximating arbitrary multi-dimensional functions of the problem space. Other implementations may use weightings associated with other types of neuromorphic functionality; for example, binary weights (0, 1) can emulate the absence or presence of connectivity. Still other implementations may use not use weights at all; for example, a thresholding accumulator may receive unweighted inputs and use adder logic rather than multiply-accumulate logic.

In some systems, each neuromorphic processing stage treats transactions asynchronously. Thus, a thresholding accumulator can receive spikes from two or more spiking elements in an asynchronous manner; i.e., the two or more somas do not need to be synchronized with one another. Each soma can generate spikes at its own rate. In other words, the thresholding accumulator concurrently receives spikes from a first spiking element of a plurality of asynchronous spiking elements. Various exemplary methods and apparatus for generating digital spikes which may be used consistent with the p[resent disclosure are described in greater detail within U.S. patent application Ser. No. 16/358,501 filed Mar. 19, 2019 and entitled “METHODS AND APPARATUS FOR SERIALIZED ROUTING WITHIN A FRACTAL NODE ARRAY”, previously incorporated herein by reference.

At step 904 of the method 900, the thresholding accumulator stores an intermediary value based on the received spikes. In one exemplary embodiment, the thresholding accumulator is an intermediate layer of a multi-layer kernel. For example, the thresholding accumulator may lay between a decoding stage and an encoding stage. In other embodiments, the thresholding accumulator may be incorporated within one or more of the layers. For example, a two-layer kernel may include a thresholding accumulator within the input layer to reduce input spike rates into the single stage (e.g., the thresholding accumulator may deprecate a spike train before processing) or reduce the output rate of the stage (e.g., the thresholding accumulator may deprecate an output spike train of the single stage). Yet other configurations will be recognized by those of ordinary skill given this disclosure.

More generally, the thresholding accumulator decouples spiking activity of one stage from downstream processing. In other words, the thresholding accumulator functionally isolates and modifies spike signaling before propagation; i.e., spikes from a soma may not immediately trigger updates to its downstream synapses. Reducing spike activity results in some information loss but has the beneficial result of reduced processing power and memory accesses.

As a brief aside, where stored intermediary state information is utilized, it can be used to enable a multi-layer kernel to consider previous transactional history in determining output; e.g., the thresholding accumulator may generate output spikes based on its previously accumulated spikes and its current input. Functionally, the intermediary value represents the state of spike activity in the threshold accumulator. For comparison, an output that is only dependent upon input (regardless of history) would be considered “stateless.”

In one embodiment, the intermediary value is a running accumulation of the decoded weight of the decode stage. In alternative embodiments, the intermediary value is an unweighted running count of spikes. Artisans of ordinary skill in the related arts given the contents of the present disclosure may substitute various other intermediary values; common examples may include e.g., spiking rates, spike density, spike modulated values, and/or any other form of signal state. For instance, a threshold accumulator may ensure that the spike rate does not exceed (or fall below) designated limits. As but one example, the threshold accumulator may cap spike rates to ensure that downstream processing is not overly complex. Another such example may actively reduce spike rates so long as the downstream SNR exceeds a minimum threshold.

Some thresholding accumulators may incorporate arithmetic logic. For example, a thresholding accumulator may decode spikes based on a decoding weight. In one such embodiment, the digital spikes may be arithmetically multiplied by a decoding weight and/or accumulated. For example, the decoding weights may be granular weights within a range. In one such case, the range may be a common range for all somas (e.g., from +1 to −1). In other implementations, the range may vary in magnitude (e.g., +2 to −2), offset (+2 to 0), and/or sign (−1 to 0) for various ones of the somas. Such variation may be on a per-soma basis, by groups of somas, or by arrays of somas (groups having a prescribed characteristic or quality).

Moreover, while the foregoing operation describes linear decoding weights for simplicity, artisans of ordinary skill in the related arts will readily appreciate that more exotic schemes may be implemented with equal success in the digital domain. For example, processing logic may implement e.g., logarithmic decoding, shifting logic, floating point logic, signed/unsigned operation, varying levels of precision, time-variant behavior (e.g., derivative and/or integral based accumulation), and/or any combination thereof.

In alternative embodiments, the intermediary value may store encoded spikes for the encode stage. For example, in an all-digital multi-layer kernel, input spikes may be encoded based at least on an encoding weight before being distributed to a decoding stage. In still other embodiments, the intermediary value may store other variants of neuromorphic manipulations; for example, the intermediary value may be periodically zeroed to clear its state (e.g., during a “soft” reset). Other such examples may include e.g., seeding or pre-seeding the intermediary values with known values so as to e.g., reproduce behavior, debug an unknown condition, return the system to a known state, and/or any other set/static configuration.

In one exemplary implementation, spikes may be asynchronous but ordered. For example, a first computational primitive may update the thresholding accumulator via a first set of transactions (e.g., memory reads/writes and/or processor multiply-accumulate (MAC) operations); thereafter, a second computational primitive can update the thresholding accumulator via a second set of transactions. These transactions may occur asynchronously, but are held off to be processed in order; in fact, some variants may even use “blocking” techniques to ensure that the thresholding accumulator is accurately updated. In other words, the first set of transactions “blocks” the second set of transactions; the second set of transactions can only be initiated once the first set of transactions has completed. Other exemplary methods and apparatus for routing digital spikes which may be used consistent with the present disclosure are described in greater detail within U.S. patent application Ser. No. 16/358,501 filed Mar. 19, 2019 and entitled “METHODS AND APPARATUS FOR SERIALIZED ROUTING WITHIN A FRACTAL NODE ARRAY”, previously incorporated herein.

While the foregoing example(s) is/are based on arithmetic operations, other implementations may use other techniques, whether alone or in combination with the foregoing. For example, the intermediary values/states may be stored within a look-up-table (LUT). During such operation, each spike may be recorded as a register read/write back. LUT implementations require memory, but greatly simplify arithmetic logic. Thus, LUT implementations may be useful where processing cycles are expensive compared to memory.

In still other implementations, spiking rate (rather than the spikes themselves) may be used to signal information. Under such implementations, digital logic may be used to calculate spiking rates, spike density, and/or other collective measures of spike train activity. Still other variants may be substituted by artisans of ordinary skill in the related arts given the present disclosure, the foregoing being purely illustrative.

Returning to FIG. 9, at step 906 of the method 900, an output spike is generated when the intermediary value meets a prescribed criterion. In one exemplary embodiment, the prescribed condition occurs where the intermediary value breaches a threshold. For example, an excitatory spike may be generated when the intermediary value exceeds an excitation threshold. Similarly, an inhibitory spike may be generated when the intermediary value falls below an inhibition threshold.

Output spiking activity may be reflected in the intermediary value. For example, the running value may increase with input excitatory spikes, and be decremented when an output excitatory spike is generated. In signed implementations, polarity may carry information; e.g., the running value may decrease with input inhibitory spikes, and be incremented when an output inhibitory spike is generated. In still other cases, output spiking may reset the intermediary value; one such implementation may use a “return-to-zero” scheme (e.g., each output spike resets the intermediary value to zero or a null value).

One notable effect of the exemplary configuration of the thresholding accumulator is that the costs/benefits of reducing spiking activity are multiplied in downstream spiking activity. In other words, the thresholding accumulator decimates spiking activity for the current stage; but the effect carries over to any subsequent processing. Existing neuromorphic systems propagate spiking in an unconstrained manner; unconstrained growth rapidly becomes untenable as each subsequent layer of processing results in exponentially more spiking activity. In contrast, the thresholding accumulator described herein advantageously limits downstream spiking at each layer thereby enabling emulation of very large spiking neural networks.

The present disclosure conveys information via spike signaling, however other forms of signaling may be deprecated in an analogous manner. For example, pulse density modulation (PDM) may deprecate pulses; pulse width modulation (PWM) may shorten pulse widths, etc. More generally, any technique for reducing digital processing load by adding sparsity may be substituted with equivalent success.

It is noted that the stage-based processing enabled by the thresholding accumulator as described herein, advantageously enables a myriad of different operational capabilities and applications. In one such particular application, the thresholding accumulator can be adjusted according to one or more operational considerations (e.g., power consumption, signal-to-noise-ratio (SNR), etc.). Generally speaking, increasing the output spiking activity increases the rate of processing complexity, memory accesses, and power consumption; however, increased rates also improve fidelity (SNR). Similarly, decreasing the output spiking activity decreases fidelity, but may greatly improve e.g., power consumption. As such, the present disclosure contemplates optimizations based on one or more of the foregoing considerations, including dynamic optimization during operation.

For instance, the sensitivity and operational costs associated with threshold operation may be dynamically changed based on a variety of application considerations. For example, a simple IoT device may prefer to operate with low power consumption. Image and voice recognition applications may require very high fidelity. Hybrid applications (e.g., with both low power operation and high-fidelity requirements) may dynamically adjust thresholds as needed. As but one such example, a neuromorphic application may seek to minimize power consumption but require a minimum signal integrity to e.g., recognize speech. Such applications may heavily decimate spikes so long as the minimum signal integrity is present. In another such example, a neuromorphic application may seek to preserve signal (e.g., audio) integrity for specific points of interest, but heavily decimate periods of inactivity (e.g., the thresholding accumulator minimally deprecates spikes only during intervals of detected speech).

In one embodiment, where multiple thresholding accumulators are present, the thresholding accumulators may have a common threshold. In other embodiments, the thresholding accumulators may have different thresholds, which may be configurable (i.e., specifiable as to value). In some embodiments, a thresholding accumulator may have multiple thresholds; for example, a positive threshold and a negative threshold. Alternative magnitude-based implementations (spikes do not carry magnitude information), may support multi-level tiers (e.g., a lower tier and a higher tier). In one exemplary embodiment, the thresholds are selected to temporally deprecate a spike train (e.g., increase the amount of time between spikes) between neuromorphic elements, including variants where varying amounts of temporal deprecation are realized via use of different threshold values.

It will be recognized that while certain embodiments of the present disclosure are described in terms of a specific sequence of steps of a method, these descriptions are only illustrative of the broader methods described herein, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure and claimed herein.

While the above detailed description has shown, described, and pointed out novel features as applied to various embodiments, it will be understood that various omissions, substitutions, and changes in the form and details of the device or process illustrated may be made by those skilled in the art without departing from principles described herein. The foregoing description is of the best mode presently contemplated. This description is in no way meant to be limiting, but rather should be taken as illustrative of the general principles described herein. The scope of the disclosure should be determined with reference to the claims.

What is claimed is:

1. A thresholding accumulator apparatus, comprising:
a first interface in communication with one or more first spiking neural network elements;
a second interface in communication with one or more second spiking neural network elements;
logic configured to store an intermediary value based at least in part on one or more input spike trains received from the one or more first spiking neural network elements; and
logic configured to generate an output spike train for transmission to the one or more second spiking neural network elements when an intermediary value meets at least one first criterion.

2. The thresholding accumulator apparatus of claim 1, wherein the at least one first criterion comprises a threshold, the threshold selected based at least on a desired signal-to-noise ratio (SNR) associated with the output spike train.

3. The thresholding accumulator apparatus of claim 2, wherein the threshold is further selected based on a corresponding cost of memory accesses to the decoding weight memory component.

4. The thresholding accumulator apparatus of claim 1, further comprising logic configured to generate another output spike train for transmission to the one or more second spiking neural network elements when the accumulated intermediary value meets at least one second criterion.

5. The thresholding accumulator apparatus of claim 4, further comprising logic configured to set the intermediary value to zero whenever an output spike of the output spike train is generated.

6. The thresholding accumulator apparatus of claim 1, further comprising:
logic configured to increase the accumulated intermediary value based on the one or more input spike trains; and
logic configured to decrease the accumulated intermediary value based on the output spike train.

7. The thresholding accumulator apparatus of claim 1, wherein the one or more first spiking neural network elements comprises digital decode logic, and the one or more second spiking neural network elements comprises analog encode circuitries.

8. A method for accumulating spiking signaling in a multi-layer kernel architecture, comprising:
receiving an input spike from a first layer of a multi-layer kernel architecture;
storing an intermediary value based on the input spike; and
generating an output spike for a second layer of the multi-layer kernel architecture when the intermediary value exceeds a threshold.

9. The method of claim 8, further comprising:
accessing a decoding weight memory apparatus to retrieve a decode weight; and
multiplying and accumulating the input spike from the first layer of the multi-layer kernel apparatus with the intermediary value based on the decode weight.

10. The method of claim 8, wherein the first layer of the multi-layer kernel architecture is associated with a first signal-to-noise ratio (SNR), and the second layer of the multi-layer kernel architecture is associated with a second SNR.

11. The method of claim 10, further comprising selecting the threshold based on an acceptable difference between the first SNR and the second SNR.

12. The method of claim 8, further comprising:
selecting the threshold based on a number of spikes required to generate the output spike; and
wherein the number of spikes required to generate the output spike corresponds to a loss in fidelity that has been determined to be acceptable.

13. The method of claim 8, further comprising setting the intermediary value to zero when the output spike is generated.

14. The method of claim 8, further comprising reducing the intermediary value by the threshold when the output spike is generated.

15. A multi-layer kernel apparatus, comprising:
a first stage of a multi-layer kernel configured to generate a first spike activity;
a second stage of the multi-layer kernel configured to generate a second spike activity; and
logic configured to isolate the first spike activity from the second spike activity.

16. The multi-layer kernel apparatus of claim 15, wherein the first stage of the multi-layer kernel comprises digital decode logic; and
the second stage of the multi-layer kernel comprises analog encode circuitry.

17. The multi-layer kernel apparatus of claim 15, wherein:
the first stage of a multi-layer kernel is configured to generate the first spike activity according to a first average spike rate and having a first signal-to-noise ratio (SNR); and
the second stage of a multi-layer kernel is configured to generate the second spike activity according to a second average spike rate and having a second SNR.

18. The multi-layer kernel apparatus of claim 17, wherein the first average spike rate exceeds the second average spike rate by at least a magnitude of ten (10).

19. The multi-layer kernel apparatus of claim 17, where the second SNR differs from the first SNR by a prescribed loss factor.

20. The multi-layer kernel apparatus of claim 19, where the prescribed loss factor is dynamically adjustable based on at least one of: (i) input originated at least in part from a user; and/or (ii) algorithmically generated input.
